(19) United States
(12) Patent Application Publication
(10) Pub. No.: US 2018/0134533 A1
(43) Pub. Date: May 17, 2018

(54) SELF-LEVELLING ATTACHMENT CARRIAGE FOR A BOOM ASSEMBLY

(71) Applicant: LinePro Equipment Ltd., Lake Country (CA)

(72) Inventor: Larry Ewert, Lake Country (CA)

(21) Appl. No.: 15/572,490

(22) PCT Filed: May 9, 2016
(86) PCT No.: PCT/CA2016/050532

§ 371 Date: Nov. 7, 2017

Related U.S. Application Data
(60) Provisional application No. 62/158,317, filed on May 7, 2015.

(51) Int. Cl. B66F 11/04; B66F 9/065

(52) U.S. Cl. CPC B66F 11/046; B66F 9/0655

(57) ABSTRACT

An attachment carriage for a hydraulic boom assembly comprises a work platform. The work platform may be a personnel basket or a fork assembly. A first actuator provides arcuate movement to the work platform about a horizontal axis. A second actuator provides rotary movement to the work platform about a vertical axis. The first actuator and the second actuator are hydraulically independent of a hydraulic system of the hydraulic boom assembly. The first actuator may be in hydraulic communication with a levelling valve. There may be means to reciprocate the work platform along the vertical axis. The first actuator and the second actuator may be integral.

### FIELD OF THE INVENTION

The present invention relates to a boom assembly and, in particular, to a self-levelling attachment carriage for the boom assembly.

### BACKGROUND OF THE INVENTION

It is known to use a self-levelling work platform for mounting on a boom assembly. U.S. Pat. No. 4,116,304, which issued on Sep. 26, 1978 to Durnell, discloses an aerial lift comprising a wheeled frame having a telescoping boom pivotally and rotatably mounted thereon. A personnel bucket is pivotally secured to one end of the boom for supporting a person therein. An electrical screw-motor apparatus is pivotally secured to and extended between the bucket and the boom. A plurality of mercury switches are mounted on the bucket and are electrically connected to the screw-motor and the source of electrical power so that the screw-motor is automatically actuated responsive to vertical movement of the boom so as to maintain the personnel bucket in a vertical position at all times. The screw-motor also acts as a snubber to prevent undesirable movement of the bucket at work levels.

U.S. Pat. No. 5,944,138, which issued on Aug. 31, 1999 to Vollmer et al., discloses a system for levelling a personnel carrying platform mounted on the end of an elongated vehicle mounted boom. A pendulum controlled hydraulic valve controls the application of fluid pressure to a pair of cylinders equipped on their ends with a series of links extending along a drum connected to the platform mounting pin. When the platform deviates from a level position, one of the cylinders is retracted to turn the platform mounting pin in a direction to correct the deviation. An interlock valve disables the platform levelling system unless the boom is being moved. A manual override valve allows the platform to be tilted for storage or other reasons.

### SUMMARY OF THE INVENTION

It is an object of the present invention to provide an improved attachment carriage which is self-levelling and has an increased range of motion.

There is accordingly provided an attachment carriage for a hydraulic boom assembly. The attachment carriage comprises a work platform. The work platform may be a personnel basket or a fork assembly. A first actuator provides arcuate movement to the work platform about a horizontal axis. A second actuator provides rotary movement to the work platform about a vertical axis. The first actuator and the second actuator are hydraulically independent of a hydraulic system of the hydraulic boom assembly. The first actuator may be in hydraulic communication with a levelling valve. There may be means to reciprocate the work platform along the vertical axis. The means to reciprocate the work platform along the vertical axis may include a telescopic linking arm. The first actuator and the second actuator may be integral.

There is also provided a boom assembly comprising a base, a first boom arm extending from the base, and a second boom arm pivotably coupled to the first boom arm. There is a hydraulic system for actuating the first boom arm and the second boom arm. An attachment carriage is pivotably coupled to the second boom arm. The attachment carriage includes a work platform. The work platform may be a personnel basket or a fork assembly. A first actuator provides arcuate movement to the work platform about a horizontal axis and a second actuator provides rotary movement to the work platform about a vertical axis. The first actuator and the second actuator are hydraulically independent of the hydraulic system for actuating the first boom arm and the second boom arm. The first boom arm may be a telescopic boom arm. The second boom arm may be a dielectric boom arm. The first actuator may be in hydraulic communication with a levelling valve. There may be means to reciprocate the work platform along the vertical axis. The means to reciprocate the work platform along the vertical axis may include a telescopic linking arm. The first actuator and the second actuator may be integral.

### BRIEF DESCRIPTIONS OF DRAWINGS

The invention will be more readily understood from the following description of the embodiments thereof given, by way of example only, with reference to the accompanying drawings, in which:

FIG. 1 is a perspective view showing an improved boom assembly mounted on a vehicle in a retracted or stowed position;

FIG. 2 is a perspective view showing the boom assembly of FIG. 1 in an extended position;

FIG. 3 is a perspective view of an attachment carriage of the boom assembly of FIG. 1, the attachment carriage being provided with a personnel basket in this embodiment;

FIG. 4 is an elevation view of the boom assembly of FIG. 1 showing a range of motion of a linking arm of the attachment carriage;

FIGS. 5A and 5B are perspective views of the attachment carriage of the boom assembly of FIG. 1 showing the personnel basket pivoting about an axis;

FIG. 6 is a perspective view of the attachment carriage of the boom assembly of FIG. 1 showing the personnel basket in a stowed orientation;

FIGS. 7A to 7D are schematics of a hydraulic system of the attachment carriage; and

FIGS. 8A and 8B are perspective views of another embodiment of an attachment carriage provided with a fork assembly.

### DESCRIPTIONS OF THE PREFERRED EMBODIMENTS

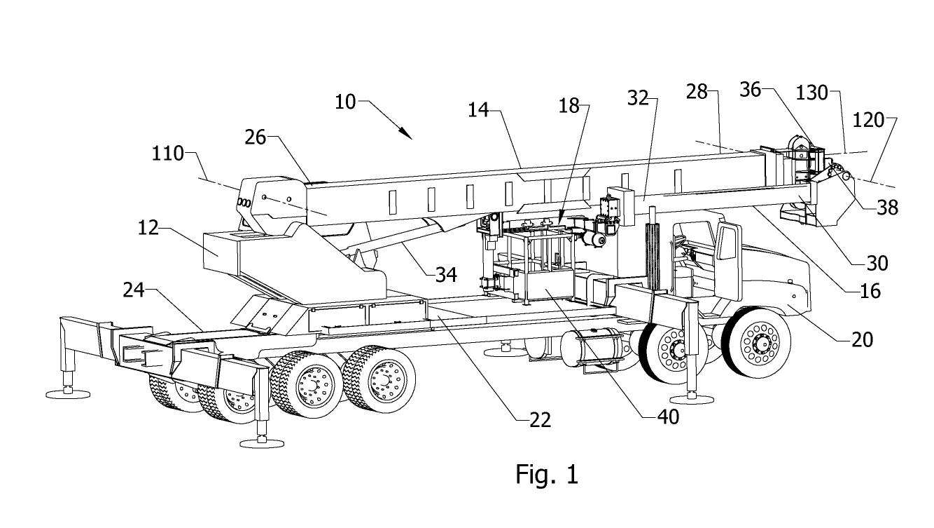

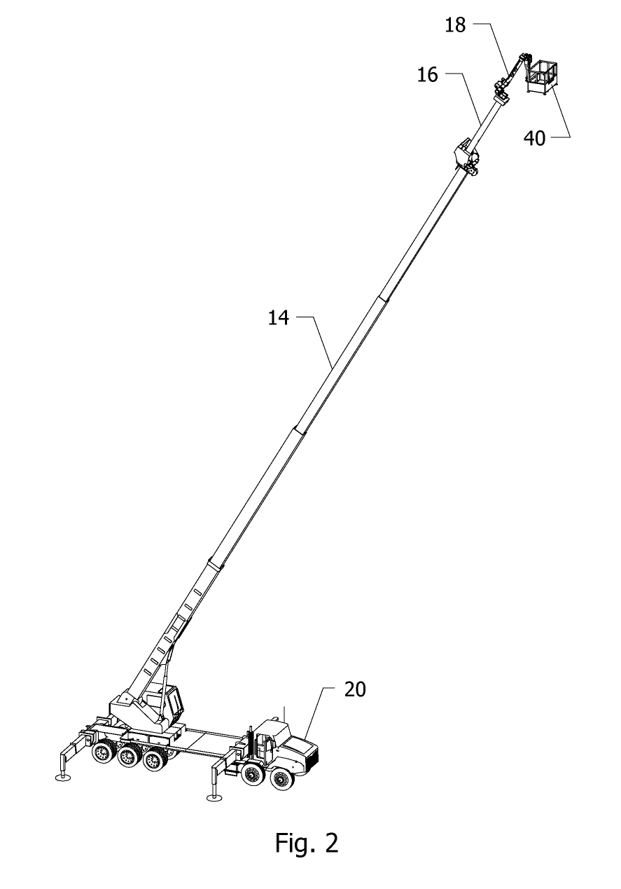

Referring to the drawings and first to FIG. 1, a boom assembly 10 is shown. The boom assembly 10 generally includes a base 12, a first boom arm 14, a second boom arm 16, and an attachment carriage 18. The boom assembly 10 is mounted on a vehicle 20 and, in particular, the base 12 of the boom assembly is mounted on a flatbed 22 of the vehicle near a rear 24 thereof. The boom assembly 10 is rotatably mounted to the vehicle 20 in this example. However, in other examples, the boom assembly 10 may be fixedly mounted on the vehicle 20. The first boom arm 14 has a proximal end 26, which is proximal with respect to the base 12, and a distal end 28 which is distal with respect to the base 12. Likewise, the second boom arm 16 has a proximal end 30, which is proximal with respect to the distal end 28 of the first boom arm 14, and a distal end 32 which is distal with respect to the distal end 28 of the first boom arm 14. The proximal end 26 of the first boom arm 14 is pivotably coupled to the base 12 in a conventional manner and there is an actuator 34 which functions to pivot the first boom arm 14 about a horizontal pivot axis 110. Hydraulic extension cylinders and cables within the first boom arm 14 move the first boom arm between a retracted position shown in FIG. 1 and an extended position shown in FIG. 2 as is well known in the art.

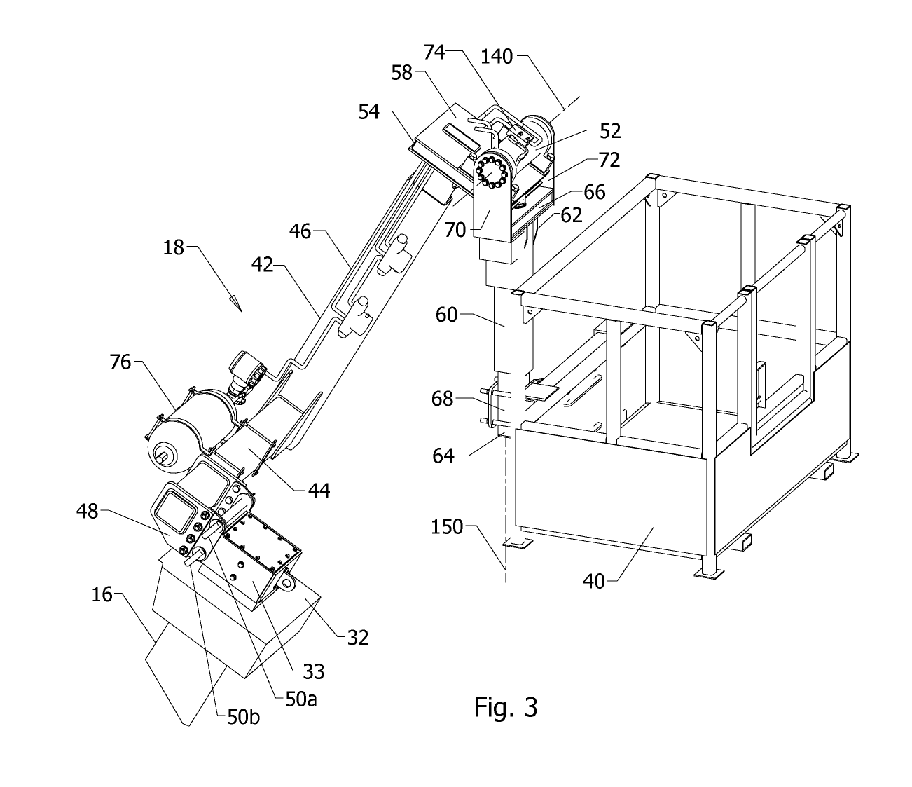

Referring back to FIG. 1, there is a bracket 36 mounted on the first boom arm 14 at the distal end 28 thereof. The bracket 36 supports an actuator 38 which, in this example, is in the form of a helical hydraulic rotary actuator. The proximal end 30 of the second boom arm 16 is coupled to the actuator 38. The actuator 38 imparts rotary motion to the second boom arm 16 such that the second boom arm is pivotable about a pivot axis 120 which is substantially perpendicular to a longitudinal axis 130 of the first boom arm 14. The attachment carriage 18 includes a work platform which, in this example, is a personnel basket 40. It will be understood by a person skilled in the art that the work platform may be a different structure in other embodiments. The attachment carriage 18 is coupled to the distal end 32 of the second boom arm 16 as best shown in FIG. 3.

The attachment carriage 18 includes a frame 42 which, in this example, is an L-shaped frame having a first arm 44 and a second arm 46. The first arm 44 of the frame 42 extends substantially perpendicular to the second boom arm 16 while the second arm 46 of the frame 42 extends substantially parallel to the second boom arm 16. The second arm 46 may be telescopic. There is a mounting bracket 48 disposed on the first arm 44 of the frame 42. The mounting bracket 48 is fixedly coupled to a sleeve 33 at the distal end 32 of the second boom arm 16 by pins 50a and 50b. There is a first actuator 52, which in this example is in the form of a helical hydraulic rotary actuator, disposed at a remote end 54 of the second arm 46 of the frame 42. The first actuator 52 is mounted on a mounting plate 58 and is coupled to the personnel basket 40 by a telescopic linking arm 60. The first actuator 52 imparts arcuate motion to the telescopic linking arm 60 such that the telescopic linking arm is pivotable about a horizontal axis 140. The telescopic linking arm 60 has a proximal end 62, which is proximal with respect to the remote end 54 of the second arm 46 of the frame 42, and a distal end 64 which is distal with respect to the remote end 54 of the second arm 46 of the frame 42. There is a U-shaped mounting bracket 66 near the proximal end 62 of the telescopic linking arm 60 and a second actuator 68 disposed near the distal end 64 of the telescopic linking arm 60. The second actuator 68 is in the form of a helical hydraulic rotary actuator in this example. Flanges 70 and 72 of the mounting bracket 66 are connected to an output of the first actuator 52 while the second actuator 68 is coupled to the personnel basket 40. The second actuator 68 rotates the personnel basket 40 about a vertical axis 150. The personnel basket 40 may also be reciprocated along the vertical axis 150 through telescoping of the telescopic linking arm 60.

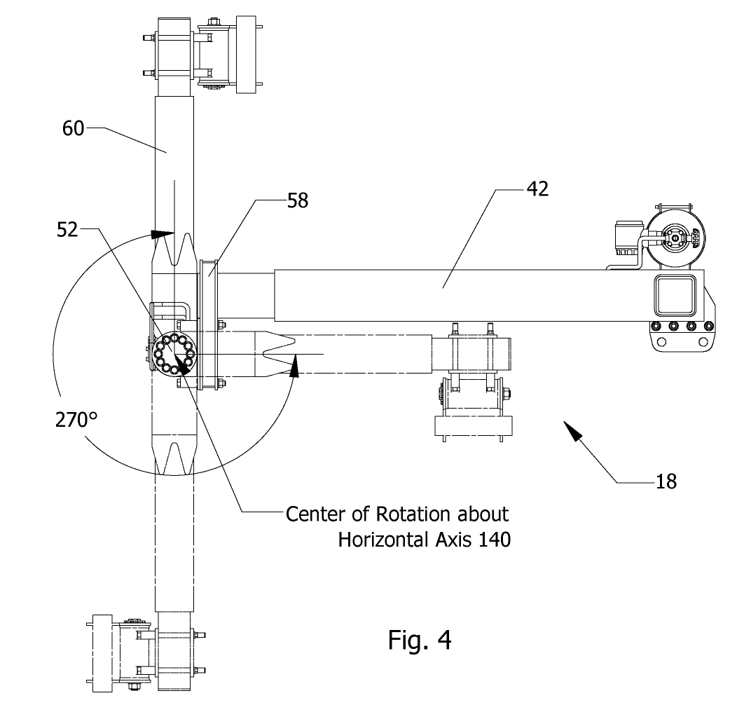

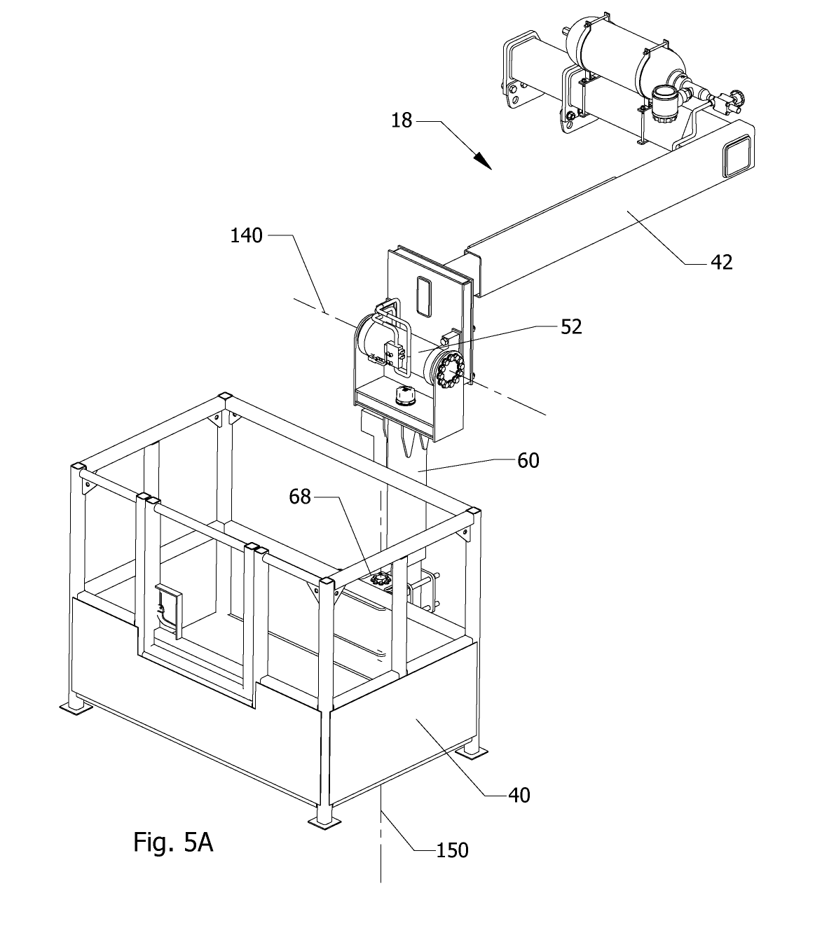

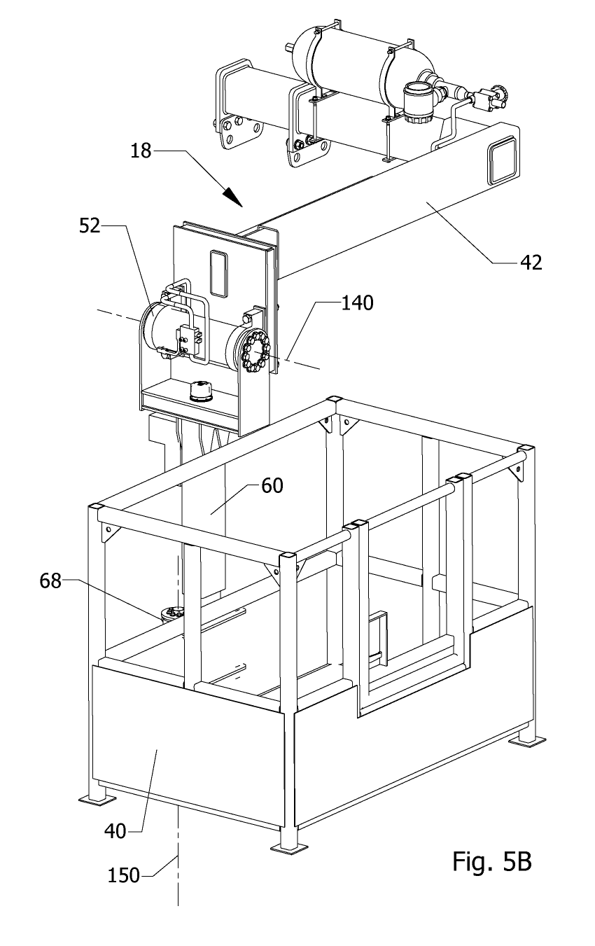

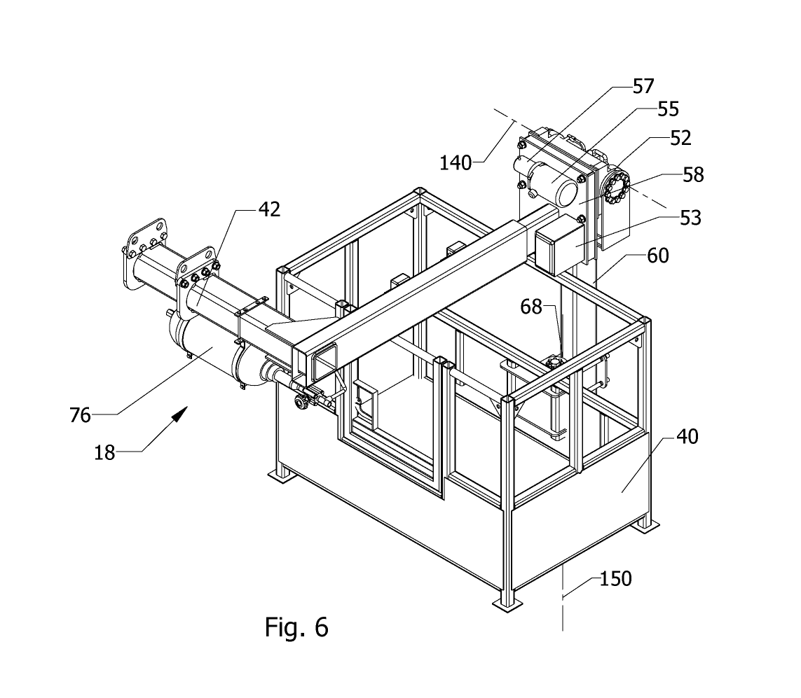

The telescopic linking arm 60 is pivotable about the horizontal axis 140 through two hundred seventy degrees as best shown in FIG. 4. The mounting plate 58 on which the first actuator 52 is mounted also functions as a stop to prevent rotation of the telescopic linking arm 60 from a stowed configuration. The personnel basket 40 is accordingly provided with arcuate movement through two hundred seventy degrees. The personnel basket 40 may also be rotated about the vertical axis 150 by the second actuator 68. This is best shown in FIGS. 5A and 5B in which the personnel basket 40 is rotated ninety degrees in FIG. 5B as compared to FIG. 5A. Referring now to FIG. 6, the personnel basket 40 is shown in a stowed orientation in which the personnel basket 40 has been rotated one hundred and eighty degrees from the position shown in FIG. 5A and the telescopic linking arm 60 has been retracted from the position shown in FIG. 5A. This facilitates stowage of the personnel basket 40 as shown in FIG. 1.

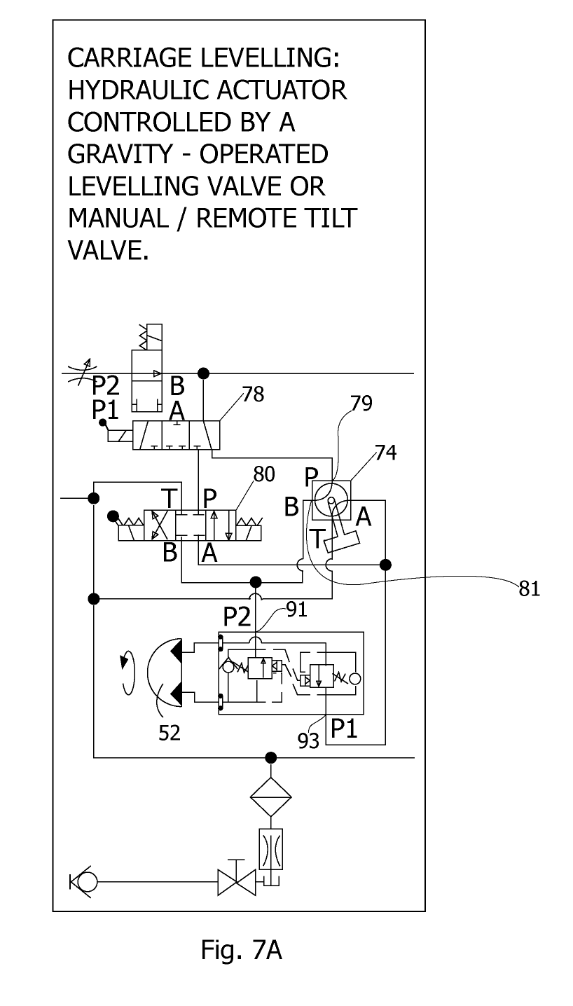

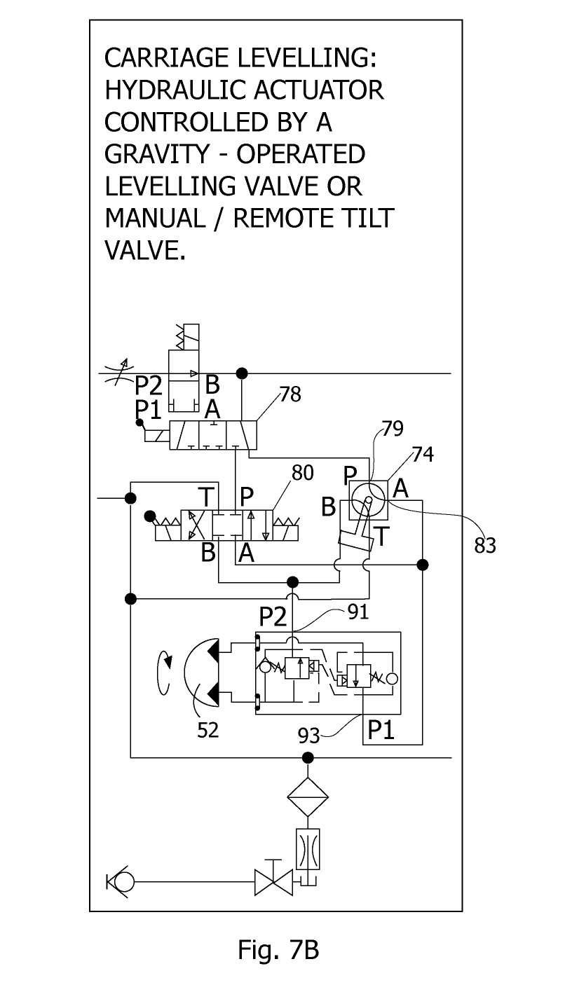

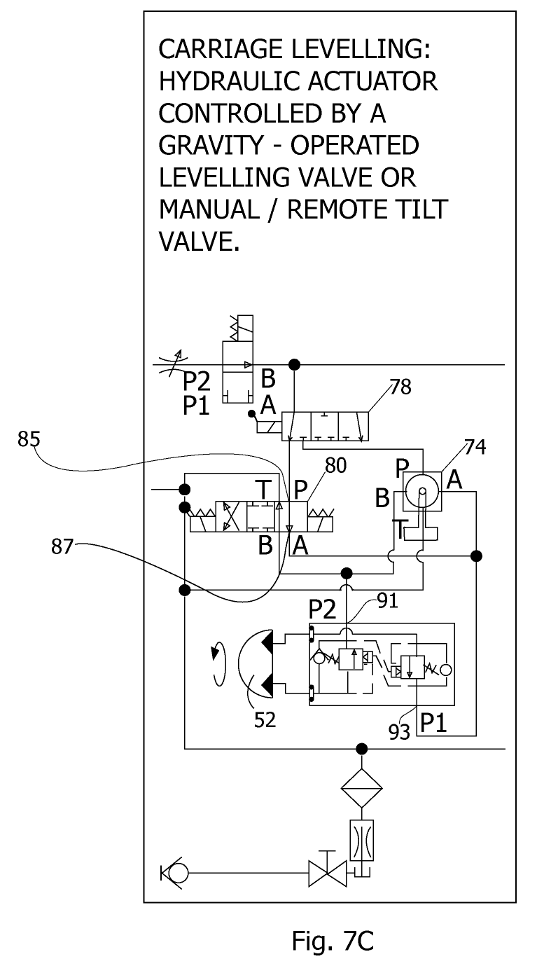

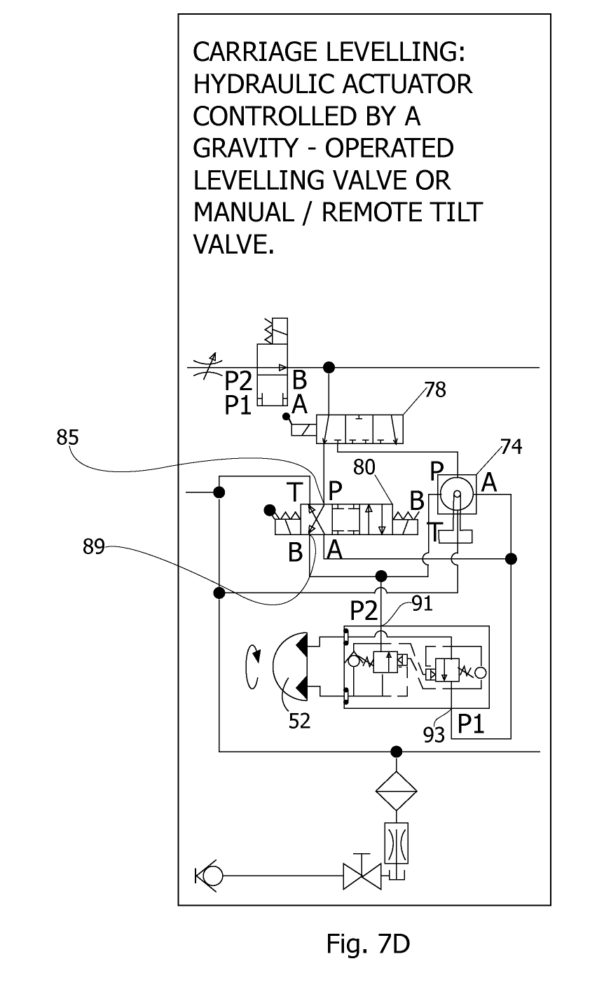

Referring back to FIG. 3, the attachment carriage 18 is provided with a levelling valve 74 which, in this example, is a gravity levelling valve. The levelling valve 74 controls hydraulic input to the first actuator 52 to ensure that the personnel basket 40 remains level when in use. In this example, the second boom arm 16 is a dielectric boom arm and the attachment carriage 18 is electrically isolated from the rest of the boom assembly 10. There is accordingly a hydraulic accumulator 76 which is mounted on the frame 42 and supplies hydraulic fluid for a hydraulic system of the attachment carriage 18. The hydraulic system of the attachment carriage 18 includes the levelling valve 74, a selector valve 78, and a directional control valve 80 which are shown in FIGS. 7A to 7D.

FIG. 7A is a hydraulic schematic showing the selector valve 78 in a gravity operated levelling valve spring return orientation. This provides hydraulic pressure to the levelling valve 74 at input Port 79 and outlet Port 81 which provides pressure to the first actuator 52 through Port 91. This pressure causes the first actuator 52 to rotate the personnel basket 40 in the counter clockwise direction to realign the pendulum to vertical orientation.

FIG. 7B is a hydraulic schematic showing the selector valve 78 in the gravity operated levelling valve spring return orientation. This provides hydraulic pressure to the levelling valve 74 at input Port 79 and outlet Port 83 which provides pressure to the first actuator 52 through Port 93. This pressure causes the first actuator 52 to rotate the personnel basket 40 in the clockwise direction to realign the pendulum to vertical orientation.

FIG. 7C is a hydraulic schematic showing the selector valve 78 enabled manually or remotely by a user. This provides hydraulic pressure to the directional control valve 80 at input Port 85 and outlet Port 87 which provides pressure to the first actuator 52 through Port 93. This pressure causes the first actuator 52 to rotate the personnel basket 40, shown in FIG. 3, in the counter clockwise direction to realign the pendulum to vertical orientation.

FIG. 7D is a hydraulic schematic showing the selector valve 78 enabled manually or remotely by a user. This provides hydraulic pressure to the directional control valve 80 at input Port 85 and outlet Port 89 which provides pressure to the first actuator 52 through Port 91. This pressure causes the first actuator 52 to rotate the personnel basket 40 in the clockwise direction to realign the pendulum to vertical orientation.

The personnel basket 40 accordingly self-levels with gravity unless otherwise directed by user inputted commands.

Referring back to FIG. 6, the attachment carriage 18 may further be provided with a power supply, which in this example is a battery 53, a motor 55 and a pump 57 for providing hydraulic pressure to the hydraulic accumulator 76 and/or other hydraulic devices such as the first actuator 52 and the second actuator 68. In this example, the battery 53, the motor 55 and the pump 57 are mounted on the mounting plate 58.

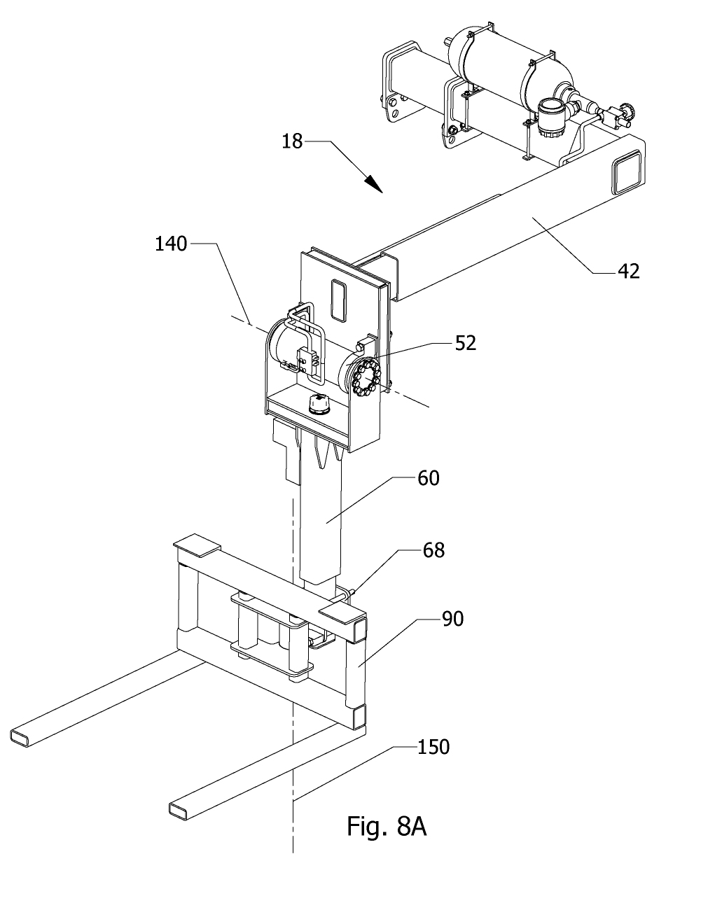

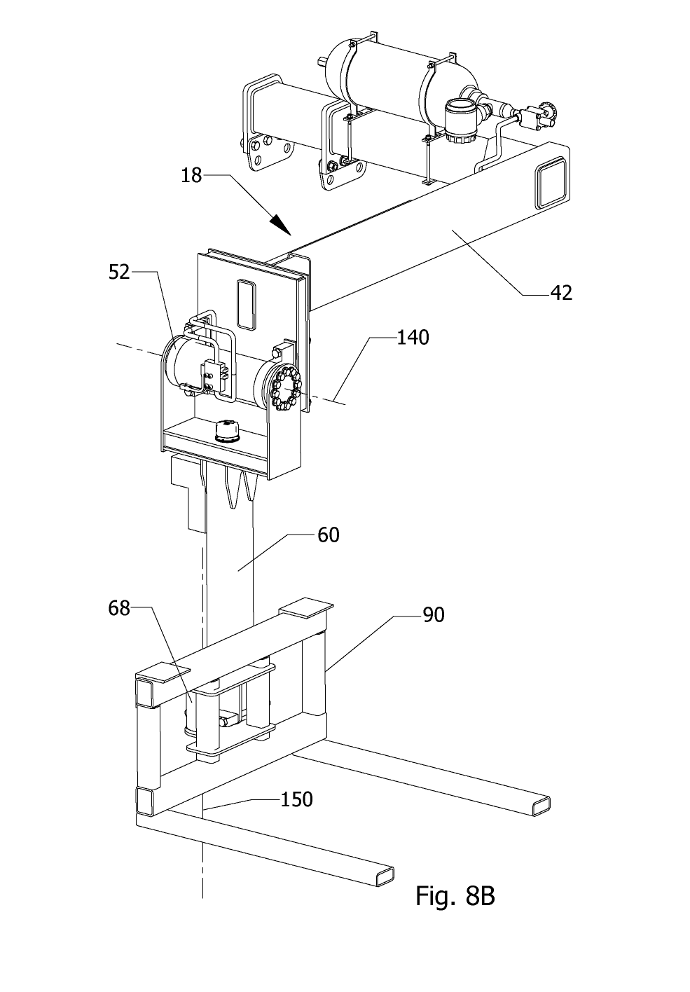

FIGS. 8A and 8B show another example of the attachment carriage 18 in which like parts have been given like reference numerals. The attachment carriage of

FIGS. 8A and 8B is substantially identical as the attachment carriage of FIGS. 5A and 5B with the exception that the work platform in this example is a fork assembly 90.

It will be understood by a person skilled in the art that in other examples a single tilt-rotating hydraulic assembly may be used to achieve horizontal and vertical articulation of the work platform.

It will also be understood by a person skilled in the art that many of the details provided above are by way of example only, and are not intended to limit the scope of the invention which is to be determined with reference to the following claims.

What is claimed is:

1. A boom assembly comprising:
a base;
a first boom arm extending from the base;
a second boom arm pivotably coupled to the first boom arm;
a hydraulic system for actuating the first boom arm and the second boom arm; and
an attachment carriage pivotably coupled to the second boom arm, the attachment carriage including a work platform, a first actuator for providing arcuate movement to the work platform about a horizontal axis and a second actuator for providing rotary movement to the work platform about a vertical axis, wherein the first actuator and the second actuator are hydraulically independent of the hydraulic system for actuating the first boom arm and the second boom arm.

2. The boom assembly as claimed in claim 1 wherein the first boom arm is a telescopic boom arm.

3. The boom assembly as claimed in claim 1 wherein the second boom arm is a dielectric boom arm.

4. The boom assembly as claimed in claim 1 wherein the first actuator is in hydraulic communication with a levelling valve.

5. The boom assembly as claimed in claim 1 further including means to reciprocate the work platform along the vertical axis.

6. The boom assembly as claimed in claim 5 wherein the means to reciprocate the work platform along the vertical axis includes a telescopic linking arm.

7. The boom assembly as claimed in claim 1 wherein the first actuator and the second actuator are integral.

8. The boom assembly as claimed in any one of claims 1 to 7 wherein the work platform is a personnel basket.

9. The boom assembly as claimed in any one of claims 1 to 7 wherein the work platform is a fork assembly.

10. An attachment carriage for a hydraulic boom assembly, the hydraulic boom assembly having a hydraulic system and the attachment carriage comprising:
a work platform;
a first actuator for providing arcuate movement to the work platform about a horizontal axis; and
a second actuator for providing rotary movement to the work platform about a vertical axis, wherein the first actuator and the second actuator are hydraulically independent of the hydraulic system of the boom assembly.

11. The attachment carriage as claimed in claim 10 wherein the first actuator is in hydraulic communication with a levelling valve.

12. The attachment carriage as claimed in claim 10 further including means to reciprocate the work platform along the vertical axis.

13. The attachment carriage as claimed in claim 10 wherein the first actuator and the second actuator are integral.

14. The attachment carriage as claimed in any one of claims 10 to 13 wherein the work platform is a personnel basket.

15. The attachment carriage as claimed in any one of claims 10 to 13 wherein the work platform is a fork assembly.
